(19) United States
(12) Patent Application Publication
(10) Pub. No.: US 2013/0063763 A1
(43) Pub. Date: Mar. 14, 2013

(54) INTEGRATED PRINTING AND NETWORK ACCESS DEVICE

(71) Applicants: Francis Kapo Tse, Rochester, NY (US); Timothy M. Hunter, Webster, NY (US); Michael Wang, Macedon, NY (US); Ramesh Nagarajan, Pittsford, NY (US)

(72) Inventors: Francis Kapo Tse, Rochester, NY (US); Timothy M. Hunter, Webster, NY (US); Michael Wang, Macedon, NY (US); Ramesh Nagarajan, Pittsford, NY (US)

(73) Assignee: Xerox Corporation, Norwalk, CT (US)

(21) Appl. No.: 13/229,031

(22) Filed: Sep. 9, 2011

(51) Int. Cl. G06F 3/12

(52) U.S. Cl. 358/1.15

(57) ABSTRACT

The present disclosure relates generally to an integrated multi-function device that is capable of both connecting to a wide area network via wired Ethernet or cellular connection and providing network connectivity to one or more devices within an internal network as part of a wireless mesh network. In some embodiments, the multi-function device may be an enhanced multi-function printing device, such as a network printer, scanner, copier, fax machine, or combination of such devices. The multi-function printing device may act as a gateway device by connecting to a WAN, such as the Internet. The multi-function printing device may further provide network access to other devices in a LAN, such as desktop and laptop computers, office telephones, cellular telephones, multimedia devices, and other printing devices, using a wireless protocol, such as the IEEE 802.11 standard.

### TECHNICAL FIELD

The present disclosure relates generally to an integrated printing and network access device that is capable of both connecting to a wide area network via wired Ethernet or cellular connection and providing network connectivity to one or more devices within an internal network as part of a wireless mesh network.

### BACKGROUND

Modern organizations, such as schools, businesses, non-profit organizations, and governmental entities, rely on the Internet for a variety of operational needs, such as electronic mail, access to websites on the World Wide Web, television and video connections, and, in some cases, telephone service, as in the case of Voice over Internet Protocol (VoIP) systems. Typical devices in an organization that require network connectivity include desktop and laptop computers, printing devices, office telephones, and multimedia devices. Some organizations also facilitate cellular telephone connectivity by providing femtocell base stations that allow employees to make and receive cellular telephone calls through the organizations' broadband connections where cellular radio waves might otherwise be too weak to permit such communications by direct transmission to and from handheld devices.

However, rather than each device connecting directly to the wide area network (WAN), organizations typically provide general network connectivity by establishing a local area network (LAN) structure in which one or more dedicated gateway devices, such as modems or proxy servers, connect directly to the WAN and provide network access to one or more additional devices in the LAN. Traditionally, such internal networks have been entirely or mostly wire-based.

However, recent advances in wireless network technology, such as the development of low-cost wireless chipsets based on the Institute of Electrical and Electronics Engineers (IEEE) 802.11n wireless specification (also known as “Wi-Fi”™), including supporting software, have caused some to question the dominant status of the traditional wired network and to propose creating entire internal networks based on a wireless mesh. While such an approach has enjoyed some success in larger, outdoor contexts, there still remains no cost-effective, integrated solution for indoor networks, such as office intranets.

One reason why internal wireless mesh networks have not taken hold is that many devices that connect to wired networks in organizational settings, such as network printers, fax machines, copiers, scanners, and other office equipment, lack native hardware support for wireless communications. As a result, in order to implement a truly wireless LAN, such devices would either need to be upgraded to include hardware support for wireless communications or would need to connect (by wired link) to various intermediary devices that could proxy communications over wireless media. Similarly, in order to convert from a wired to a wireless mesh network, many organizations would be forced to purchase new gateway devices that connect to the WAN and/or wireless routers to act as nodes in the wireless mesh network. The consequent need to purchase new replacement and complementary wireless devices, thus, acts as a cost and logistics barrier to wireless conversion.

Therefore, there is a need for a simplified, cost-effective technique for creating an internal wireless mesh network that reduces, rather than increases, the number of devices necessary to implement the wireless mesh network.

### SUMMARY OF THE INVENTION

The present disclosure relates generally to an integrated multi-function device that is capable of both connecting to a wide area network via wired Internet or wireless cellular connection and providing wireless network connectivity to one or more devices within an internal network. In some embodiments, the multi-function device may be an enhanced multi-function printing device, such as a network printer, scanner, copier, fax machine, or combination of such devices.

A multi-function printing device may act as a gateway device by connecting to a WAN, such as the Internet. The multi-function printing device may further provide network access to other devices in a LAN, such as desktop and laptop computers, office telephones, cellular telephones, multimedia devices, and other printing devices, using a wireless protocol, such as the IEEE 802.11 standard. In some cases, devices in the LAN may connect directly to a multi-function printing device that is acting as a gateway device to the WAN. In other cases—for example, where physical distances would prevent a strong direct wireless connection between a gateway multi-function printing device and other devices in the LAN—multiple multi-function printing devices may be chained together to provide a wireless mesh network throughout a building space.

The gateway multi-function printing device may connect to the WAN using a wired connection, such as a standard Ethernet connection, as governed by the IEEE 802.3 standard, or an asynchronous transfer mode (ATM) connection. In other embodiments, the gateway multi-function printing device may connect to the WAN using a wireless cellular connection.

### BRIEF DESCRIPTION OF THE DRAWINGS

The accompanying drawings, which are incorporated in and constitute a part of this specification, illustrate various embodiments of the invention and, together with the description, serve to explain the principles of the invention. In the drawings:

FIG. 1 is a diagram depicting an exemplary wireless mesh network implemented using a plurality of integrated multi-function printing devices, consistent with certain disclosed embodiments; and

FIG. 2 is a diagram depicting exemplary hardware componentry in an exemplary integrated multi-function printing device, consistent with certain disclosed embodiments.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations, and other implementations are possible, without departing from the spirit and scope of the invention. Accordingly, the following detailed description does not limit the invention. Instead, the proper scope of the invention is defined by the appended claims.

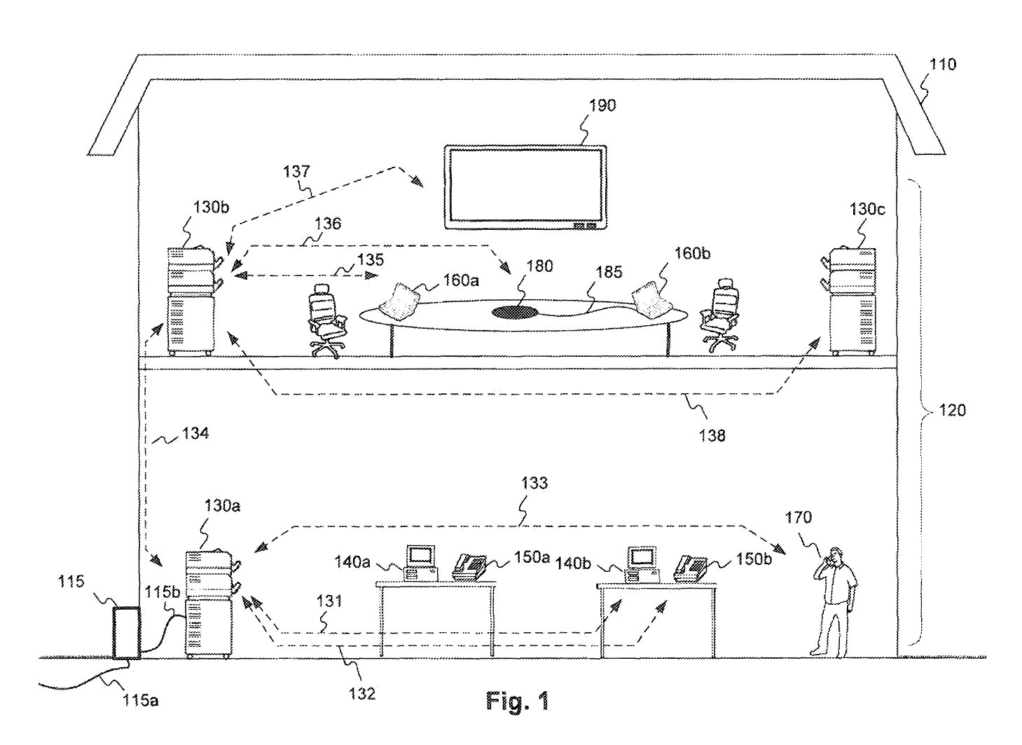

FIG. 1 is a diagram depicting an exemplary wireless mesh network implemented using a plurality of integrated multi-function printing devices, consistent with certain disclosed embodiments. As depicted in FIG. 1, an organization may occupy a building space 110. Although depicted as occupying two floors in FIG. 1, those skilled in the art will appreciate that building space 110 may comprise any arrangement of office equipment within one or more physical enclosures, and may include an arrangement of devices in separate offices, cubicles, rooms, or other types of horizontal arrangements, and may also span one or more floors, levels, or other types of vertical arrangements.

Building space 110 may contain various electronic and communication devices, such as, without limitation, one or more multi-function printing devices 130a-c; one or more desktop computer workstations 140a-b; one or more telephones 150a-b; one or more laptop computers 160a-b; one or more mobile devices 170, such as mobile telephones, personal digital assistants (PDAs), or smartphones; one or more network connection hubs 180; or one or more multimedia display devices 190, such as televisions; etc. Such devices may be communicatively linked together to form one or more local area networks (LANs) 120. LAN 120 may link the devices together such that they may communicate with each other and/or connect to one or more gateway devices providing connectivity to a wide area network (WAN), such as the Internet.

In some embodiments, rather than employ separate gateway devices such as stand-alone modems, LAN 120 may utilize one or multi-function printing devices 130 to provide connectivity to a WAN. Multi-function printing devices 130 may comprise hardware, software, and/or firmware componentry for performing traditional printing operations, such as printing, copying, faxing, or scanning documents, papers, or other materials. For example, desktop computer workstations 140 may connect to multi-function printing devices 130 to send electronic copies of documents for printing on physical paper. Employees may also use multi-function printing devices 130 for copying physical paper documents, which operation may or may not require a network connection. Employees may also insert papers into multi-function printing devices 130, which may scan such papers, generate one or more electronic files representing the papers, and store the electronic files in network storage or transit the electronic files by email. Multi-function printing devices 130 may additionally or alternatively transmit or receive facsimiles, either by traditional analog telephone line or through a digital network connection.

Although described herein as “multi-function printing” devices, those skilled in the art will appreciate that such devices need not actually provide more than one printing or scanning function in order to practice the disclosed embodiments, nor need such devices perform actual printing on paper (e.g., scanning might be accomplished without actually printing on paper). However, in certain unique aspects of the invention, devices 130 may be distinguished from traditional network access provider devices in their ability both to perform network access provision and to perform operations that involve the manipulation of physical paper objects, such as printing, copying, scanning, or faxing.

As depicted in FIG. 1, devices resident in LAN 120 may connect to a WAN (not depicted) through multi-function printing device 130a. Multi-function printing device 130a may connect to a WAN using any one of several different techniques. In one embodiment, multi-function printing device 130a may connect by wire 115b to a WAN using a cable connection, such by coaxial cable line; a telephone connection, such as a digital subscriber line (DSL); a digital telecommunications carrier system connection, such as a 1.544 megabit per second (Mbps) T1 line or multiplexed T2 or T3 circuit channels; twisted pair copper wiring; fiber-optic medium; or other wired means. Multi-function printing device 130a may access a WAN by connecting to an Internet Service Provider (ISP), either directly or through intermediary devices, such as an optical network terminal 115 capable of converting signals from a fiber-optical line 115a to copper wiring resident in building space 110 and vice-versa. Multi-function printing device 130a may connect to a WAN over such wired media using any number of different wired protocols, such as Ethernet, as described in the Institute of Electrical and Electronics Engineers (IEEE) 802.3 standard; asynchronous transfer mode (ATM), synchronous optical networking (SONET), synchronous digital hierarchy (SDH), token ring, Fiber Distributed Data Interface (FDDI); etc.

In other embodiments, multi-function printing device 130a may connect to a WAN using a cellular connection, such as, without limitation, an analog or “1G” connection, Global System for Mobile Communications (GSM) or “2G” connection, Enhanced Data rates for GSM Evolution (EDGE) connection, Universal Mobile Telecommunications System (UMTS) or “3G” connection, or “4G” connection technologies, such as Worldwide Interoperability for Microwave Access (WiMAX) (e.g., as set forth in IEEE standard 802.16) or Long Term Evolution (LTE). The cellular connection may employ any combination of code division multiple access (CDMA), frequency division multiple access (FDMA), time division multiple access (TDMA), or other medium sharing technologies.

Once connected to a WAN, multi-function printing device 130a may operate as a network access provider to other devices in LAN 120. In some embodiments, in order to facilitate operation of a wireless mesh network, multi-function printing device 130a may provide network access to various devices using one or more wireless connections 131-138. Multi-function printing device 130a may provide network access to various devices in LAN 120 over a wireless access protocol, such as the Wi-Fi™ standard, as set forth in the IEEE 802.11 family of standards.

For example, desktop computer workstation 140b may connect to multi-function printing device 130a using wireless connection 131, which it may use to, inter alia, connect to the Internet or connect to one or more other devices resident in LAN 120, such as shared network drives (not depicted). Similarly, telephone 150b may be used to place and receive telephone calls over a Voice over Internet Protocol (VoIP) using wireless connection 132 to connect to the Internet. Moreover, by using a wireless connection 132 to place and receive telephone calls over a VoIP, telephone 150b may be relocated to any location within building space 110 in which it can continue to maintain a wireless connection with one or more multi-function printing devices 130a-b. Thus, an employee who is expecting a call on his or her office phone, may move the phone to a different location in building space 110, such as a conference room, while still maintaining the ability to place and receive telephone calls using the same telephone number.

Multi-function printing device 130a may also provide network access to one or more mobile devices 170, such as mobile telephones or smartphones, over a wireless connection 133. For example, for mobile telephones that are capable of communicating using one or more wireless Ethernet standards, such as 802.11, such mobile telephones may place and receive telephone calls using one or more VoIP standards. Smartphones, in addition to placing and receiving telephone calls using a wireless Ethernet connection, may also use wireless connection 133 to perform other network operations, such as sending and receiving transmission control protocol/Internet protocol (TCP/IP) packets in order to provide for application layer communications, such as web browsing using the hypertext transfer protocol (HTTP), email using the simple mail transfer protocol (SMTP), determining IP addresses associated with domain names through the domain name system (DNS) protocol, etc.

For mobile telephones that are not configured to communicate over a wireless Ethernet connection, but only over cellular connections such as GSM, UMTS, etc., multi-function printing device 130a may function as a femtocell. When operating as a femtocell, multi-function printing device 130a may connect to a cellular telephone service provider via broadband connection—e.g., using the techniques described above. Multi-function printing device 130a may then provide wireless connection 133 as a cellular connection, rather than a wireless Ethernet connection, using cellular standards such as GSM, CDMA, WiMAX, LTE, etc. Under this scenario, mobile telephone 170 may place and receive calls using the cellular wireless connection 133 with multi-function printing device 130a.

Multi-function printing device 130a may receive cellular wireless signals from mobile telephone 170, convert such signals into Ethernet (or other wired protocol) frames, and transmit such frames to one or more cellular telephone service providers over, for example, a wired connection. In this way, employees may place and receive cellular telephone calls via multi-function printing device 130a in the event that direct signal communication between mobile telephone 170 and a cellular telephone tower would be too attenuated within building space 110.

In some embodiments, the disclosed multi-function printing device may be used not only as a gateway device with LAN 120, but also to implement a wireless mesh network throughout building space 110. For example, it may be the case that multi-function printing device 130a is sufficiently physically remote from some devices in LAN 120 that it may not be possible to establish a strong enough wireless connection between multi-function printing device 130a and those devices. Thus, a second multi-function printing device 130b may be used to further extend the wireless network provided by multi-function printing device 130a.

As depicted in FIG. 1, multi-function printing device 130a may establish a wireless connection 134 to multi-function printing device 130b. Unlike multi-function printing device 130a, multi-function printing device 130b may not act as a gateway device by directly connecting to a WAN. Rather, multi-function printing device 130b may act as a wireless network access provider to devices 130c, 160a, 180, and 190, which may be out of range to receive wireless access directly from multi-function printing device 130a. Such devices may connect to a WAN, such as the Internet, by establishing a wireless connection with multi-function printing device 130b.

For example, multi-function printing device 130b may establish a wireless connection 135 with laptop 160a. Thus, to transmit an electronic message to a device external to LAN 120 (e.g., an HTTP request, an SMTP message, etc.), laptop 160a may transmit the message wirelessly to multi-function printing device 130b. For example, using a wireless Ethernet 802.11 standard, laptop 160a may divide its message into a series of sequential frames, addressed to a media access control (MAC) address associated with multi-function printing device 130b. Such frames may be further multiplexed within one or more network layer datagrams (e.g., IP datagrams) addressed to a device that is external to LAN 120.

Laptop 160a may transmit each frame when it detects that a channel is available and no other devices are transmitting frames on the channel at the same time. Multi-function printing device 130b may receive such frames and may determine that such frames are addressed to it as a link layer device. Multi-function printing device 130b may then determine that the message itself is directed to a device external to LAN 120 by consulting one or more IP addresses contained in the IP datagrams. Accordingly, multi-function printing device 130b may then re-address the frames to a MAC address associated with multi-function printing device 130a and transmit the modified frames to multi-function printing device 130a.

Multi-function printing device 130a may receive the frames from multi-function printing device 130b. Multi-function printing device 130a may also modify the frames to include a MAC address associated with a link layer device or other intermediary device within the WAN for forwarding the message to the intended recipient device. Additionally, or alternatively, multi-function printing device 130a may convert any 802.11 frames to 802.3 frames for transmission on a wired medium. Likewise any communications received from devices external to LAN 120 may be initially received by multi-function printing device 130a, which may forward such communications to multi-function printing device 130b. Multi-function printing device 130b may then forward the communications to laptop 160a. Those skilled in the art will appreciate that the foregoing example of steps involved in forwarding communications is exemplary only.

Multi-function printing device 130b may similarly act as an intermediary wireless access provider for device 180, which may be a network access hub for use in conference room settings. For example, multi-function printing device 130b may establish a wireless connection 136 with hub 180. Hub 180 may then provide for one or more wired connections 185 to devices, such as laptop 160b, that are not capable of wireless connection. Multi-function printing device 130b may also provide wireless network access for one or more multi-media devices 190, such as televisions or radios, through wireless connection 137.

Multi-function printing device 130b may also provide wireless network access for other printing devices, such as multi-function printing device 130c, through wireless connection 138. In some embodiments, multi-function printing device 130c may not be configured to provide network access to other devices, but may simply be a traditional consumer of network access. In other embodiments, multi-function printing device 130c may be configured similarly to multi-function printing device 130b, and may therefore further extend the wireless mesh network to devices in building space 110 or LAN 120 (not depicted) that are too remote from multi-function printing device 130a or multi-function printing device 130b to establish high quality wireless connections. In such a configuration, multi-function printing device 130c may forward communications from devices addressed to external devices by transmitting the communications to multi-function printing device 130b, which may then forward the communications to multi-function printing device 130a, which may then forward the communications to devices within a WAN, such as the Internet.

As described above, in certain embodiments, multi-function printing device 130a may connect to the WAN using one or more cellular wireless connections—for example, using CDMA, TDMA, FDMA, etc. Because such cellular connections may have less bandwidth than traditional wired connections, such as a T1 line or even DSL, and because multiple devices within LAN 120 may need to share that bandwidth, multi-function printing device 130a may additionally be configured to maximize any available cellular bandwidth when providing network access to such devices.

For example, during a given time period, multi-function printing device 130a may provide network access to desktop computer workstation 1406, telephone 150b, and television 190 concurrently. Rather than simply forwarding each device's communications individually to the WAN, multi-function printing device 130a may first collect any data packets or frames received from the LAN devices. Once collected, multi-function printing device 130a may combine or package data received from the LAN devices into data packets or frames designed for optimal use of cellular bandwidth. Such operations may involve resizing data packets or frames received, throttling or reordering data from one or more devices to maximize time-usage of the cellular medium, as well as reversing any such operations for individual transmission back to the LAN devices for communications received from the WAN. Multi-function printing device 130a may also operate as a proxy server by terminating TCP connections or HTTP requests from devices in LAN 120 and retransmitting such requests directly to WAN recipients, and vice-versa.

Multi-function printing devices 130a-c may also utilize the wireless connections 134 and 138 between themselves to implement distributed processing of network printing, scanning, faxing, or other jobs. For example, for certain operationally expensive graphical image processing tasks, such as raster image processing or file conversion, multi-function printing devices 130a-c may engage in load balancing by determining which printing devices presently have the highest capacity and distributing some or all of the task to those printing devices.

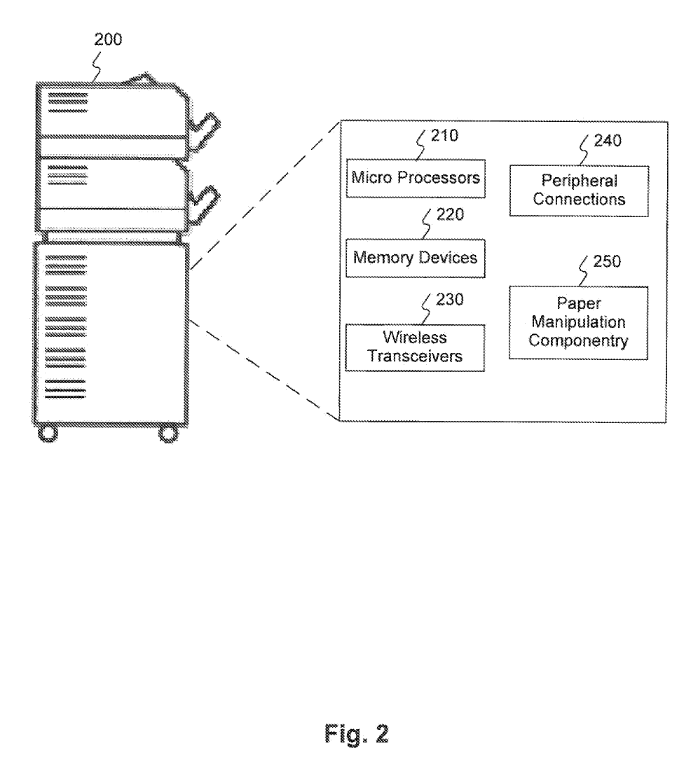

FIG. 2 is a diagram depicting exemplary hardware componentry in an exemplary integrated multi-function printing device 200, consistent with certain disclosed embodiments. Although depicted in FIG. 2 as a multi-function printing device, such as a combination network printer and scanner, integrated multi-function device 200 is not limited to printing devices specifically, but may comprise any device that is typically a consumer of network access that has been converted into a provider of network access using the above-described techniques.

Using the example of a multi-function printing device, device 200 may comprise one or more microprocessors 210 of varying core configurations and clock frequencies; one or more memory devices or computer-readable media 220 of varying physical dimensions and storage capacities, such as flash drives, hard drives, random access memory, etc., for storing data, such as data packets or frames, images, files, and program instructions for execution by one or more microprocessors 210; one or more wireless transceivers 230 for communicating over wireless protocols, such as wireless Ethernet, code divisional multiple access (CDMA), time division multiple access (TDMA), etc.; one or more peripheral connections 240, such as universal serial bus (USB) connections or video interfaces; and one or more paper manipulation components 250, such as components for using toner to print on paper, optical sensors for scanning or copying paper, mechanical trays or revolving cylinders for inputting or outputting physical paper, etc. Those skilled in the art will appreciate that the above-described componentry is exemplary only, as device 200 may comprise any type of hardware componentry, including any necessary accompanying firmware or software, for performing the disclosed embodiments.

The foregoing description of the invention, along with its associated embodiments, has been presented for purposes of illustration only. It is not exhaustive and does not limit the invention to the precise form disclosed. Those skilled in the art will appreciate from the foregoing description that modifications and variations are possible in light of the above teachings or may be acquired from practicing the invention. For example, the disclosed integrated printing and network access device may be used only to provide wireless network access to one or more devices in a LAN without connecting directly to the WAN itself (e.g., connecting instead by wired or wireless medium to a separate dedicated gateway device or proxy server for access to the WAN). Similarly the described LAN need not be confined to a single building or building space, but may, in some instances, be spread across multiple buildings, either by wired or wireless medium.

Those skilled in the art will also appreciate that the steps described need not be performed in the same sequence discussed or with the same degree of separation. Likewise various steps may be omitted, repeated, or combined, as necessary, to achieve the same or similar objectives or enhancements. Accordingly, the invention is not limited to the above-described embodiments, but instead is defined by the appended claims in light of their full scope of equivalents.

What is claimed is:

1. An integrated paper manipulation and network access device comprising:
a paper manipulation unit configured to physically manipulate paper products;
a network interface unit configured to connect to a wide area network (WAN); and
a wireless communication unit configured to provide access to the WAN to one or more devices in a local area network (LAN) via one or more wireless connections, wherein the paper manipulation unit, the network interface unit, and the wireless communication unit are contained within a single physical enclosure.

2. The device of claim 1, wherein:
the wireless communication unit is further configured to receive one or more electronic instructions to print on the paper products from the one or more devices in the LAN; and
the paper manipulation unit is further configured to print on the paper products in accordance with the one or more electronic instructions.

3. The device of claim 1, wherein:
the paper manipulation unit is further configured to:
scan a paper document using one or more optical sensors; and
create a digital graphical representation of the paper document; and
the wireless communication unit is further configured to transmit the digital graphical representation to the one or more devices in the LAN.

4. The device of claim 1, wherein:
the paper manipulation unit is further configured to:
scan a paper document using one or more optical sensors; and
create a digital graphical representation of the paper document; and
the network interface unit is further configured to transmit the digital graphical representation to one or more devices in the WAN.

5. The device of claim 1, wherein the network interface unit is further configured to:
receive a communication from a first device in the LAN addressed to a second device in the LAN via the one or more wireless connections; and
forward the communication to the second device in the LAN via the one or more wireless connections.

6. The device of claim 5, wherein forwarding the communication to the second device in the LAN comprises:
transmitting the communication directly to the second device via the one or more wireless connections.

7. The device of claim 5, wherein forwarding the communication to the second device in the LAN comprises:
transmitting the communication to an intermediary integrated paper manipulation and network access device.

8. The device of claim 1, wherein the network interface unit is configured to connect to the WAN using a wired communication link.

9. The device of claim 8, wherein the network interface unit is further configured to communicate with one or more devices in the WAN via the wired communication link using an 802.3 protocol.

10. The device of claim 1, wherein the network interface unit is configured to connect to the WAN using a wireless communication link.

11. The device of claim 10, wherein the network interface unit is further configured to communicate with one or more devices in the WAN via the wireless communication link using one of a GSM, CDMA, FDMA, TDMA, 2G, 3G, or 4G protocol.

12. The device of claim 1, wherein the wireless communication unit is configured to provide access to the WAN to the one or more devices in the LAN using an 802.11 protocol.

13. The device of claim 1, wherein the network interface unit is configured to:
receive an electronic communication from a device within the WAN addressed to the one or more devices in the LAN; and
forward the electronic communication to the one or more devices in the LAN.

14. The device of claim 13, wherein forwarding the electronic communication to the one or more devices in the LAN comprises transmitting the electronic communication to the one or more devices in the LAN via the one or more wireless connections using an 802.11 protocol.

15. The device of claim 14, wherein receiving the electronic communication from the device within the WAN comprises receiving the electronic communication via a wired connection using an 802.3 protocol.

16. The device of claim 1, wherein the network interface unit is configured to:
receive an electronic communication from the one or more devices in the LAN addressed to a device within the WAN; and
forward the electronic communication to the device within the WAN.

17. The device of claim 16, wherein forwarding the electronic communication to the device within the WAN comprises transmitting the electronic communication to the device within the WAN via a wireless connection using one of a GSM, CDMA, FDMA, TDMA, 2G, 3G, or 4G protocol.

18. The device of claim 17, wherein receiving the electronic communication from the one or more devices in the LAN comprises receiving the electronic communication via a wireless connection using an 802.11 protocol.
